(19) United States
(12) Patent Application Publication
(10) Pub. No.: US 2019/0315320 A1
(43) Pub. Date: Oct. 17, 2019

(54) Trailer braking system

(71) Applicant: Richard W. Job, Ankeny, IA (US)

(72) Inventors: Benjamin J. Maat, Spring Lake, MI (US); Carter Davis, Lansing, MI (US); Nathan J. Goering, Portland, MI (US); Jesse L. Lassila, Wetmore, MI (US); Nicholas J. Monette, Lake Linden, MI (US); Jacob W. Pardy, Buchanan, MI (US)

(73) Assignee: Richard W. Job, Ankeny, IA (US)

(21) Appl. No.: 15/954,278

(22) Filed: Apr. 16, 2018

(51) Int. Cl. B60T 1/06; F16D 55/225; B60T 7/20; B60T 8/176; B60T 7/04; B60D 1/64; F16D 65/18; B60T 8/17; B60T 8/32; B60T 13/74

(52) U.S. Cl. CPC B60T 1/065; F16D 55/225; B60T 7/20; B60T 8/176; B60T 7/042; F16D 2127/02; F16D 65/18; B60T 8/17; B60T 8/321; B60T 13/746; B60T 2240/00; B60D 1/64

(57) ABSTRACT

A system for braking a trailer pulled by a vehicle. A trailer braking system is provided on a trailer. An electrically actuated linear actuator of the trailer braking system is coupled to the braking system of the pulling vehicle. The linear actuator is coupled to a lever that, upon actuation of the vehicle brake, actuates a piston to push brake pads into a rotor coupled a wheel on the trailer. A wheel speed monitor reduces braking force of the trailer braking system in response to a predetermined change in wheel speed. An anti-lock braking system reduces trailer wheel skid under braking. Multiple trailer braking systems can be applied to multiple wheels on the trailer to provide more or less braking.

### TECHNICAL FIELD

The disclosed embodiments relate generally to a trailer braking system, and, in particular, to a trailer braking system that, upon actuation of the towing vehicle brake, controls the braking of a trailer to prevent the trailer from pushing the towing vehicle under braking, while reducing skidding of the trailer's wheels.

### BACKGROUND

In an agricultural environment, such as a tractor pulling one or more trailers, it is desirable to provide the trailer with a separate braking system to allow the tractor trailer “train” to stop quicker under braking. Failure to provide the trailer with a separate braking system can cause the trailer to push the tractor under braking, leading to a longer stopping distance, which can lead to collisions and/or damage to the tractor and/or trailers.

Prior art systems for providing trailers with separate braking systems are typically hydraulically or pneumatically driven. One drawback with prior art hydraulic systems is the tendency of the hydraulic lines to operate less efficiently, or not at all, in very cold weather. Since cold weather is often associated with ice on roadways, the reduced operability of hydraulic braking systems in cold weather can compromise a trailer's braking ability when it is most needed. Prior art pneumatic braking systems can also suffer from reduced functionality in colder weather if moisture gets into the system and freezes in the pneumatic lines. Additionally, pneumatic systems require an air compressor to pressurize the system, adding to the weight, maintenance, and cost of such systems.

Another drawback associated with prior art trailer braking systems is that such systems often require a separate hand actuator apart from the vehicle brake pedal to operate. This can be cumbersome and may lead to the trailer brake being actuated late, or not at all in critical situations where maximum braking is required to avoid a potential accident.

Yet another drawback associated with prior art trailer braking systems is the difficulty in retrofitting such systems to existing trailers. Prior art trailer braking systems are often customized to the particular trailer, making it difficult to provide a sufficient selection of trailer braking systems to fit all existing trailers. Another drawback associated with prior art systems is the difficulty associated with powering such systems. The output from a typical seven-pin connector plug is generally insufficient to provide adequate braking for large trailers and/or large loads.

Still another drawback associated with prior art trailer braking systems is the difficulty associated with properly adjusting the amount of braking to be applied to the trailer in relationship to the amount of braking applied to the tractor. Too little braking applied to the trailer can cause the trailer to push the tractor under braking. Too much braking applied to the trailer can cause the trailer to skid under braking. While some prior art trailer braking systems are provided with adjustable braking, the difficulty associated with anticipating the exact amount of trailer braking needed for different loads often leads the trailer to brake too much or too little, even after adjustment.

### SUMMARY OF THE DISCLOSED SUBJECT MATTER

To overcome the limitations in the prior art described above, and to overcome other limitations that will become apparent upon reading and understanding the present specification, the present application discloses a method, apparatus, and article of manufacture for braking a trailer. A tractor trailer braking system is provided. A linear actuator is coupled to the existing braking system of the pulling vehicle. The linear actuator is coupled to a lever that, upon actuation of the pulling vehicle brake, actuates a piston that pushes the brake pad into a rotor coupled to a wheel on the trailer. Multiple systems can be applied to multiple wheels on the trailer to provide more or less braking. A wheel speed monitor allows the braking system to reduce the braking force of the trailer braking system in response to a predetermined change in trailer wheel speed.

Other implementations of trailer braking systems are disclosed, including implementations directed to powered and self-charging trailer braking systems.

### BRIEF DESCRIPTION OF THE DRAWINGS

The present invention will now be described, by way of example, with reference to the accompanying drawings in which:

FIG. 1 illustrates a side perspective view of a tractor and trailer equipped with the braking system in accordance with one embodiment;

FIG. 2 illustrates a perspective view of the brake applicator in accordance with one embodiment;

FIG. 3 illustrates an exploded view of the brake applicator in accordance with one embodiment;

FIG. 4 illustrates a perspective view of the lever of the brake applicator in accordance with one embodiment;

FIG. 5 illustrates a perspective view of the lever mount of the brake applicator in accordance with one embodiment;

FIG. 6 illustrates a perspective view of the caliper mount of the brake applicator in accordance with one embodiment;

FIG. 7 illustrates a block diagram of the system architecture of the braking system in accordance with one embodiment; and

FIG. 8 illustrates a flow chart of the braking process of the brake applicator in accordance with one embodiment.

### DETAILED DESCRIPTION OF THE DRAWINGS

The system of the present invention uses a signal associated with a vehicle brake to brake a trailer being pulled by the vehicle. The system monitors the wheel speed of the trailer to apply a desired amount of braking, while the anti-lock feature of the braking system reduces the tendency of the tires of the trailer to skid under braking. The system stores power to direct a greater amount of electricity to the braking process than is provided from standard seven-pin trailer connections. The system also maintains a positive emergency braking condition without requiring a constant supply of electricity and automatically engages the braking system in the event the trailer becomes inadvertently disengaged from the tractor.

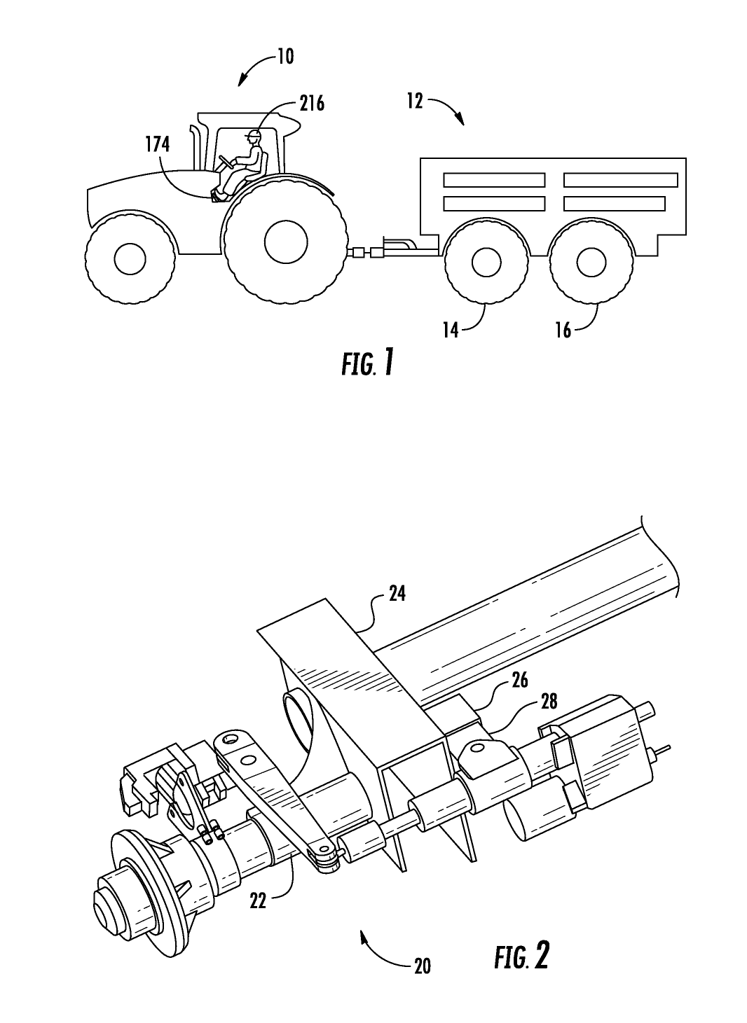

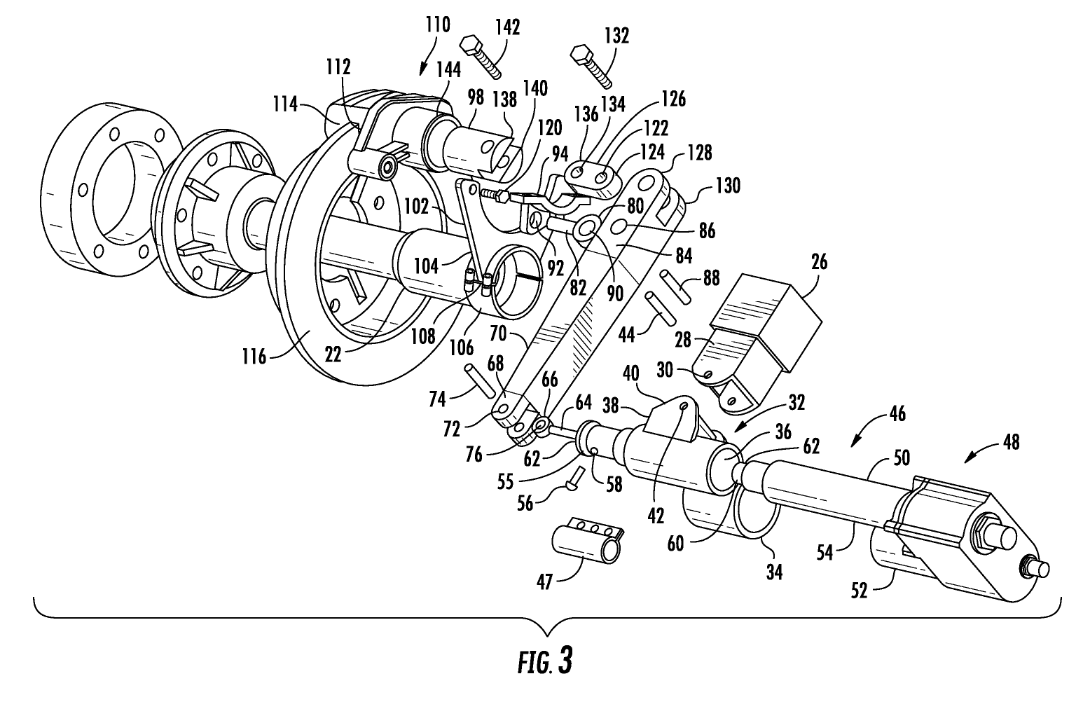

As shown in FIG. 1, a powered wheeled vehicle, such as a tractor (10), is shown mechanically and releasably coupled to a trailer (12) having a plurality of wheels (14) and tires (16) in a manner such as that known in the art. The tractor (10) and trailer (12) are part of a braking system (18) having a brake application assembly (20) such as that shown in FIG. 2. (FIGS. 1-3, and 7). While only a single brake application assembly (20) will be shown and described, it should be noted that any desired number of brake application assemblies (20) may be provided for any desired number of wheels (14) on the trailer (12). As shown in FIGS. 1-3, the wheel (14) is coupled to an axle (22) of the trailer (12), which in turn is coupled to a frame (24) of the trailer (12) in a manner such as that known in the art. The brake application assembly (20) has a linear actuator mount (26) welded or otherwise secured to the frame (24). The linear actuator mount (26) is provided with a pair of ears (28), each provided with a hole (30). A linear actuator sleeve (32) is provided having two steel tubes (34) and (36) welded to one another. The linear actuator sleeve (32) is also provided with a mounting bracket (38) having a pair of ears (40), each having a hole (42). The holes (30) of the linear actuator mount (26) are aligned with the holes (42) of the mounting bracket (38) and a pin (44) is provided through the holes (30) and (42) and secured in place by a nut (not shown) or similar securement device.

A linear actuator (46) is slidably provided through the linear actuator sleeve (32). The linear actuator (46) may be of any desired type. In one embodiment, the linear actuator (46) is a PA-17 model electric linear actuator supplied by Progressive Automations of Blaine, Wash., USA. The linear actuator (46) is provided with a housing (48) having a brushed direct current (DC) motor that runs on 12V DC with a full load current of 20 amps and that drives a screw (not shown) coupled to an extensible arm (50). The linear actuator (46) has a stroke length of 1-24 inches, supplies a force of 800 pounds at 0.33 inches per second and 2000 pounds at 0.66 inches per second. The linear actuator (46) is provided with a sensor to detect and output the current position of the extensible arm (50). Any desired linear actuator (46) may be used, preferably having a stroke length of between one half to forty inches long and capable of supplying a force of between 100 and 5000 pounds at between one tenth and five inches per second. The linear actuator (46) is secured within the linear actuator sleeve (32) in a manner such that the portion (52) of the housing (48) housing the motor is provided through one of the steel tubes (34) and the portion (54) of the housing (48) housing the screw is provided through the other steel tube (36). The linear actuator (46) is secured within the linear actuator sleeve (32) by a standard compression clamp (47) or the like.

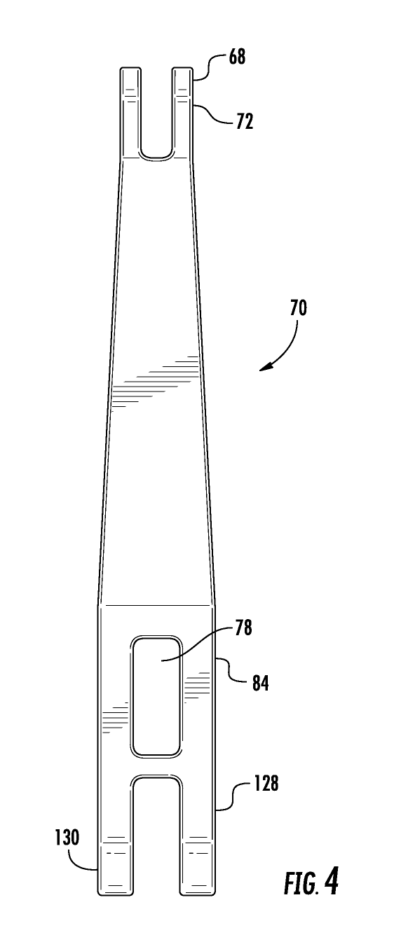

A lever connector (55) is secured over the end of the extensible arm (50) by a screw (56) passing through a hole (58) in the lever connector (55) and threaded into a threaded hole (60) provided in the extensible arm (50). The lever connector (55) is provided with a threaded end (62) into which is screwed a rod end bearing (64) having a spherical rod end joint (66). The spherical rod end joint (66) is positioned between two ears (68) of a lever (70), each having a hole (72). As shown in FIGS. 2-3, a pin (74) is secured through the holes (72) of the lever (70) and through a hole (76) in the spherical rod end joint (66). The lever (70) may be constructed of any suitable material and dimensions. In one embodiment, the lever (70) is constructed out of steel as shown in FIG. 4. The lever (70) is provided with a cavity (78) sufficiently large to accept the spherical rod end joint (80) of a rod end bearing (82). Provided in walls (84) on either side of the cavity (78) are holes (86) to accommodate a pin (88). The pin (88) passes through a hole (90) in the spherical rod end joint (80) to hold the rod end bearing (82) in place.

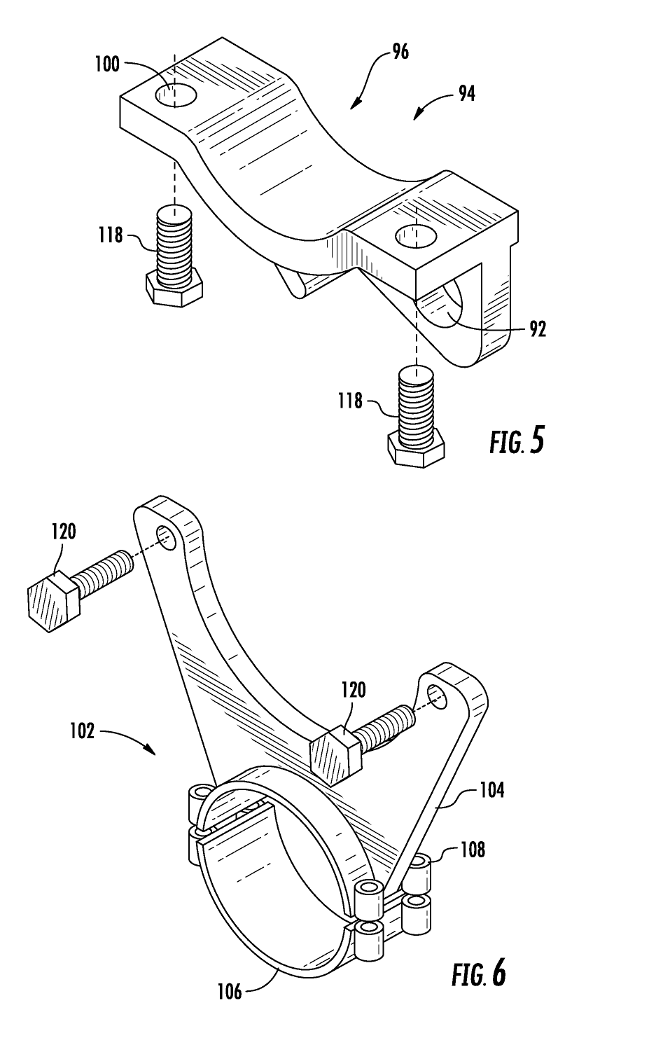

As shown in FIGS. 2-5, the rod end bearing (82) is screwed into a threaded hole (92) of a lever mount (94). As shown in FIG. 5, the lever mount (94) is provided with a curvature (96) to accommodate a piston, such as a cylindrical brake plunger (98). The lever mount (94) is also provided with holes (100) to allow the lever mount (94) to be screwed into securement with a floating disc brake caliper assembly (110) with two bolts (118). The floating disc brake caliper assembly (110) is secured to the axle (22) by a caliper mount (102). As shown in FIG. 6, the top (104) and bottom (106) of the caliper mount (102) are provided around the axle (22) and secured into place with four bolts (108). The floating disc brake caliper assembly (110) has two brake pads (112) and (114) positioned over a standard brake rotor (116) coupled to the wheel (14) in a manner known in the art. (FIGS. 1-5). As the braking system (18) of the present invention is designed to be easily retrofit on an existing trailer (12), if the trailer (12) is not already provided with rotors (116), in one embodiment, 6-lug Duralast brake rotors from a 2001 Isuzu Trooper are retrofit onto the trailer (12). (FIGS. 1-2, and 7). While any suitable floating disc brake caliper assembly (110) may be used, in one embodiment of the invention, a floating disc brake caliper assembly (110) from a 2000 Chevrolet Cavalier is employed. Two bolts (120) secure the disc brake caliper assembly (110) to the side of the caliper mount (102).

A hole (122) in one end (124) of a solid steel linkage (126) is positioned between two ears (128) and (130) of the lever (70) and pivotally secured thereto by a bolt (132). A hole (134) in the other end (136) of the solid steel linkage (126) is positioned between two ears (138) and (140) of the brake plunger (98) and pivotably secured thereto by a bolt (142). The brake plunger (98) is positioned into a sleeve (144) on the caliper assembly (110).

Once the brake application assembly (20) is installed and adjusted as desired, actuation of the linear actuator (46) pulls the lever (70) which pushes the brake plunger (98), which causes the brake pads (112) and (114) of the caliper assembly (110) to engage the rotor (116) and slow the trailer (12). When it is desired to reduce braking, the linear actuator (46) is actuated in reverse, pushing the lever (70) which pulls the brake plunger (98), causing the floating disc brake caliper assembly (110) to move the brake pads (112) and (114) away from the rotor (116) to allow the wheel (14) of the trailer (12) to turn more freely.

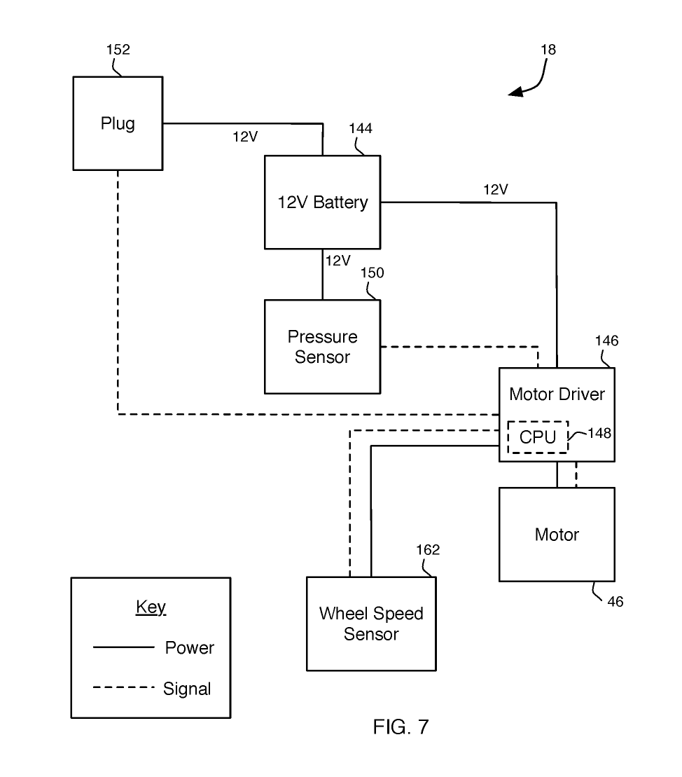

As shown in FIG. 7, the braking system (18) is provided with an electrical power storage system, such as a 12V power source (144). While the power source (144) may be a capacitor, or any desired power source, in one embodiment of the invention, the power source (144) is a battery. Power supplied by the 12V/Aux power from the tractor's seven-pin connector plug (152) is used to recharge the power source (144). The power source (144) is coupled to a power controller (146), which in the preferred embodiment is a MDC2230 brushed motor controller supplied by Roboteq, Inc. of Scottsdale, Ariz., USA. The power controller (146) is provided with a computer, such as a central processing unit (CPU) (148) and a program storage unit, such as computer memory incorporated into the power controller (146) and readable by the CPU (148) to execute one or more instructions as explained in more detail below. The power controller (146) is capable of converting power from the power source (144) into either a low voltage 3.3V output for the wheel speed sensor (162), or a high voltage and high current output for the brake application assembly (20). The power controller (146) is coupled to the linear actuator (46) to provide variable power to the linear actuator (46) based on the current demand and to receive input from the sensor on the linear actuator (46) which provides the power controller (146) with information as to the current position of the extensible arm (50). The CPU (148) is preferably integrated into the power controller (146), but may, alternatively, be a stand alone CPU, or be a CPU incorporated into a different component of the braking system (18).

The CPU (148) is coupled to various sensors, including a pressure sensor (150) that in one embodiment is a TD1000 Pressure Transducer supplied by Transducers Direct of Cincinnati, Ohio. The pressure sensor (150) is preferably coupled into engagement with a prior art brake line hydraulic pressure testing port on the tractor (10). (FIGS. 1 and 7). If the tractor (10) is already provided with plug capable of outputting the hydraulic pressure in the brake line of the tractor (10), the braking system (18) can be provided with an adapter to fit into engagement with the plug instead of, or in addition to, the pressure sensor (150). Monitoring the hydraulic pressure in the brake line of the tractor (10) is preferred, since it provides information not only that the brakes of the tractor (10) are being applied, but the force with which they are being applied. This allows the braking system (18) to vary the pressure applied to the caliper assemblies (110) associated with the trailer (12) to apply more braking force on the trailer when there is more braking force on the tractor (12) and to apply less braking force on the trailer when there is less braking force on the tractor (12). (FIGS. 1-2 and 7). Alternatively, if it is not desired to brake the trailer (12) as a function of the amount of braking force applied to the tractor (10), the braking system (18) can be coupled directly to the vehicle brake, which in one embodiment is the brake pedal of the tractor (12), or to the brake light signal line of the tractor's seven-pin connector plug (152).

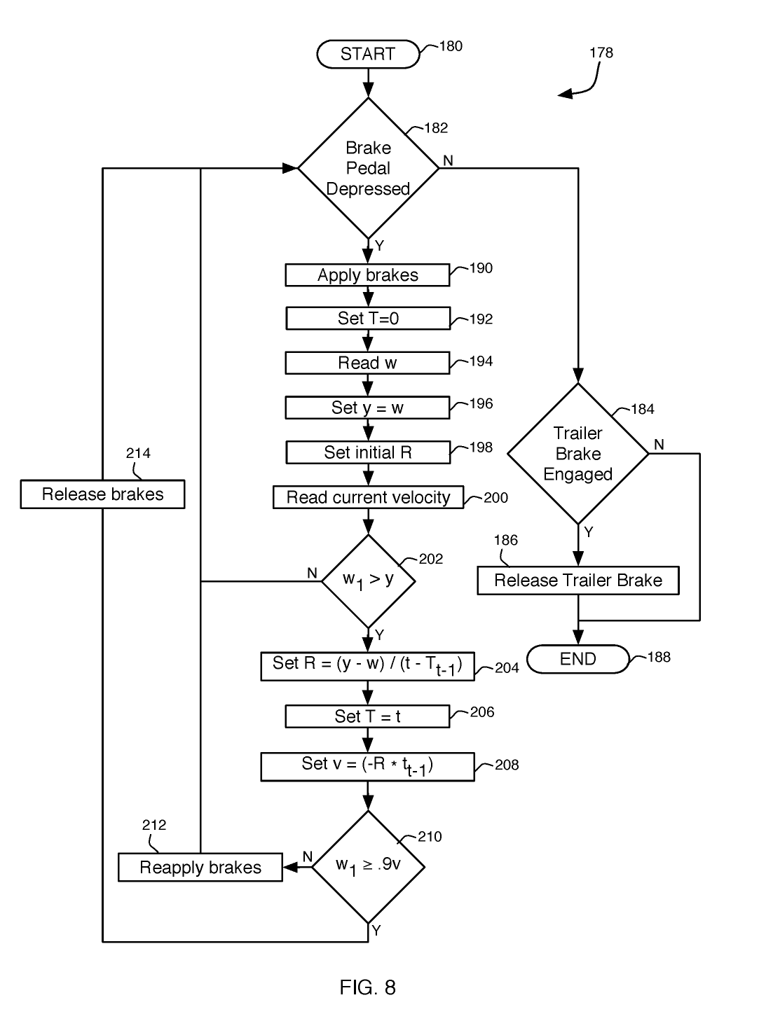

A wheel speed sensor (162), which in one embodiment is a SNG-QPLA-000 Hall Effect Sensor supplied by Honeywell, International, Inc., is coupled to the CPU (148) and monitors the speed of the wheel (14). In addition to controlling standard braking of the trailer (12) through the linear actuator (46), the CPU (148) also functions as a braking release system and an anti-lock braking system (ABS) (178). FIG. 8 is a flow diagram showing the steps typically performed by the braking system (18) for engaging the ABS (178). (FIGS. 2, and 7-8). Engagement of the ABS (178) starts (180) with the CPU (148) determining (182) if the tractor (10) is braking by receiving a brake light signal from the tractor's seven-pin connector plug (152). The CPU (148) then receives from the pressure sensor (150), a signal reflecting the degree to which, if any, braking force is being applied to the tractor (10) by application of the tractor's hydraulic braking system. (FIGS. 1-2, and 7-8). If the pressure sensor (150) is not sending a signal that a braking force is being applied to the tractor (10) by application of the tractor's hydraulic braking system, the process determines (184) if the linear actuator (46) is engaging the caliper assembly (110) to brake the trailer (12). If the CPU (148) does not receive both the brake light signal from the tractor's seven-pin connector plug (152) and a signal from the pressure sensor (150) that braking force is being applied to the tractor (10) by application of the tractor's hydraulic braking system, the CPU (148) stops braking the trailer (12). If the linear actuator (46) is engaging the caliper assembly (110) to brake the trailer (12), the CPU (148) signals (186) the power controller (146) to reverse the linear actuator (46) and release the caliper assembly (110). The process then terminates (188). If the linear actuator (46) is not engaging the caliper assembly (110) to brake the trailer (12), the process simply terminates (188).

If the CPU (148) does receive both the brake light signal from the tractor's seven-pin connector plug (152) and a signal from the pressure sensor (150) that braking force is being applied to the tractor (10) by application of the tractor's hydraulic braking system, the CPU (148) signals the power controller (146) to actuate the linear actuator (46) to apply braking force (190) to the rotor (116) via the caliper assembly (110). The CPU (148) runs an algorithm that initializes a time signal (t) and sets (192) a time (T) to zero. The CPU (148) uses the algorithm to determine (194) an initial rotational velocity (w) of the wheel (140) via inputs from the wheel speed sensor (162) and sets (196) an initial estimated trailer velocity (y) to the initial rotational velocity (w) of the wheel (140). The CPU (148) sets (198) an initial gain value (R), and reads (200) the current rotational velocity (w₁) of the wheel (140) at Tₜ₋₁. The CPU (148) compares (202) the estimated trailer velocity (y) with the current rotational velocity (w₁) of the wheel (140). If (w₁) exceeds (y), the CPU (148) sets (204) R to (y−w)/(t−ₜ₋₁). If that calculation results in a change in R, the CPU (148) sets (206) T to t. The CPU (148) sets (208) the estimated velocity of the trailer where (v) equals (−R*tₜ₋₁)+y. If the CPU (148) determines (210) that the current rotational velocity (w₁) of the wheel (14) is at or above 90% of the estimated velocity (v) of the trailer, the CPU signals the power controller (146) to reactuate (212) the linear actuator (46) to apply additional braking force, or alternatively, the same braking force, to the rotor (116) via the caliper assembly (110). The process then returns to step (182) to determine if braking force is still being applied to the tractor (10) by application of the tractor's hydraulic braking system. If the CPU (148) determines (210) that the current rotational velocity (w₁) of the wheel (140) is below 90% of the estimated velocity (v) of the trailer, the CPU (148) signals the power controller (146) to reverse (214) the linear actuator (46) to reduce braking force to the rotor (116) via the caliper assembly (110). The process then returns to step (184) to determine if braking force is still being applied to the tractor (10) by application of the tractor's hydraulic braking system. The CPU (148) continues as described above, applying and releasing the caliper assembly (110) up to several times per second until the process terminates (188). The CPU (148) can alternatively be programmed to actuate the ABS (178) if it determines (210) that the current rotational velocity (wᵢ) of the wheel (140) is below 50% or above 99% of the estimated velocity (v) of the trailer (12) or anywhere in between.

With the exception of the ABS functionality, the CPU (148) applies a braking force proportional to the braking force inputted to the CPU (148) when the tractor brake lights come on and brake light signal is conveyed through a female seven-pin connector plug (152) to the CPU (148). For simplicity, this will be referred to as the braking state. With the exception of the ABS functionality, the CPU (148) returns the brake pads (112) and (114) to a predetermined distance away from the rotor (116) when the brake light signal goes off. This will be referred to as the non-braking state. When the ABS functionality of the CPU (148) detects an irregularly steep deceleration of the trailer, the CPU (148) will switch the braking system (18) into a non-braking state until wheel velocity returns to normal. This process may cause the rapid switching between braking and not braking associated with prior art ABS systems.

The CPU (148) relies on five inputs: the power in, the brake light on signal, the brake system pressure sensor, the current position sensor of the linear actuator (46), and the wheel speed sensor. The output of the CPU (148) goes to the power controller (146) that outputs the required voltage to the linear actuator (46). The CPU (148) can immediately switch its output from closed loop position tracking to no torque output to the caliper assemblies (110). This allows the CPU (148) to apply accurately proportioned force outputs, and accurately float the pads (112) and (114) a predetermined distance away from the brake rotor (116) when braking is not required.

When it is desired to actuate the parking brake feature of the braking system (18), the tractor operator (216) depresses the brake pedal (174) of the tractor (10) and turns the tractor (10) off while the brake pedal (174) is still being depressed. When this happens, the CPU (148) receives a signal from the pressure sensor (150) that braking force is being applied to the tractor (10) by application of the tractor's hydraulic braking system and the CPU (148) signals the power controller (146) to actuate the linear actuator (46) to apply braking force (190) to the rotor (116) via the caliper assembly (110). Then, when the tractor operator (216) turns the tractor (10) off, the CPU (148) is receives input from the wheel speed sensor (162) that the wheels (14) of the trailer (12) are not turning, and that the braking system (18) is not receiving 12V/Aux power from the tractor's seven-pin connector plug (152). In this event, the CPU (148) takes no further action and leaves the linear actuator (46) applying the same braking force (190) to the rotor (116) via the caliper assembly (110) that it did before the tractor (10) was turned off. Because braking pressure in the braking system (18) is applied with a mechanical linear actuator (46), rather than a pneumatic or hydraulic system, no power is required for the linear actuator (46) to maintain this braking force (190) indefinitely. The tractor operator (216) simply shuts the power off on the tractor (10) with the brake pedal (174) depressed and the braking system (18) remains engaged. When the tractor operator (216) wants to resume operation the tractor operator (216) simply starts the tractor (10) and steps on the brake pedal (174), causing the CPU (148) to receive a signal from the pressure sensor (150) that braking pressure has been applied to the tractor (10) by the operator (216). The operator (216) then releases the brake pedal (174) and resumes operation. In response to the pressure sensor (150) sending a signal that braking pressure has been released on the tractor (10) by the operator (216), the CPU (148) signals the power controller (146) to actuate the linear actuator (46) to release the braking force (190) to the rotor (116) via the caliper assembly (110). In a similar manner, if the trailer (12) becomes inadvertently detached from the tractor (10) while in motion, the CPU (148) is programmed to actuate the linear actuators (46) to apply braking force from the caliper assemblies (110) to the rotors (116). In one embodiment this automatic braking upon breakaway functionality is triggered if the female seven-pin connector plug (152) located on the tractor (10) becomes detached from the male seven-pin connector plug located on the trailer (12). In this event the CPU (148) of the braking system (18) is receiving input from the wheel speed sensor (162) that the wheels (14) of the trailer (12) are turning, but the braking system (18) is not receiving 12V/Aux power from the tractor's seven-pin connector plug (152). Once this condition is met, the CPU (148) signals the power controller (146) to actuate the linear actuator (46) to apply braking force to the rotor (116) via the caliper assembly (110). The braking upon breakaway functionality can be set to either fully apply the caliper assemblies (110) until the trailer (12) stops, or employ the ABS system described above to stop the trailer (12) without skidding.

Although the invention has been described with respect to a preferred embodiment thereof, it is to be understood that it is not to be so limited since changes and modifications can be made therein which are within the full, intended scope of this invention as defined by the appended claims.

What is claimed is:

1. A braking system comprising:
(a) a powered wheeled vehicle;
(b) a trailer releasably coupled to the vehicle, wherein the trailer comprises:
i an axle; and
ii a wheel coupled to the axle;
(c) an electric linear actuator comprising:
i a housing; and
ii an extensible arm provided at least partially within the housing and at least partially extensible in relationship thereto;
(d) wherein the housing is coupled to the trailer;
(e) a lever having a first end and a second end, wherein the first end of the lever is coupled to the extensible arm;
(f) a piston having a first end and a second end, wherein the first end of the piston is coupled to the second end of the lever;
(g) a brake rotor; and
(h) a brake pad coupled to the second end of the piston in sufficient proximity to the brake rotor to allow the pad to move into and out of contact with the brake rotor as the extensible arm retracts and extends relative to the housing.

2. The braking system of claim 1, further comprising a supplemental brake pad, wherein the brake rotor is positioned between the brake pad and the supplemental brake pad.

3. The braking system of claim 1, further comprising a wheel speed sensor coupled to the wheel.

4. The braking system of claim 3, wherein the rotor is coupled the wheel.

5. The braking system of claim 3, further comprising a braking release system coupled to the wheel speed sensor and to the linear actuator.

6. The braking system of claim 5, wherein the braking release system is configured to actuate the linear actuator in response to the wheel speed sensor detecting a predetermined change in the speed of the wheel.

7. The braking system of claim 1, further comprising an antilock braking system coupled to the linear actuator.

8. The braking system of claim 7, wherein the antilock braking system is configured to actuate the linear actuator in response to the antilock braking system detecting a predetermined locking of the wheel under braking.

9. The braking system of claim 1, further comprising an electrical power storage system provided on the trailer and coupled to the linear actuator.

10. The braking system of claim 9, wherein the electrical power storage system is an electrical capacitor.

11. The braking system of claim 1, further comprising a brake pedal located on the vehicle and coupled to the linear actuator in a manner such that depression of the brake pedal actuates the linear actuator.

12. The braking system of claim 11, further comprising a vehicle brake, wherein the linear actuator is configured in a manner such that depression of the brake pedal causes the linear actuator to exert sufficient force on the lever to slow the trailer sufficiently so that the trailer exerts a braking force on the vehicle.

13. The braking system of claim 11, further comprising a computer provided on the trailer and a program storage medium readable by the computer and tangibly embodying one or more instructions executable by the computer to perform a method for braking the trailer, the method comprising:
(a) receiving input associated with depression of the brake pedal; and
(b) actuating the linear actuator in response to receipt of the input.

14. The braking system of claim 13, wherein the input associated with depression of the brake pedal is received from a seven-pin connector plug provided on the vehicle.

15. A trailer braking system for a trailer coupled to a vehicle, the braking system comprising:
(a) an electric linear actuator comprising:
i a housing;
ii an extensible arm provided at least partially within the housing and at least partially extensible in relationship thereto; and
iii wherein the housing is coupled to the trailer;
(b) a lever having a first end and a second end, wherein the first end of the lever is coupled to the extensible arm;
(c) a piston coupled having a first end and a second end, wherein the first end of the piston is coupled to the second end of the lever;
(d) a brake rotor;
(e) a brake pad coupled to the second end of the piston in sufficient proximity to the brake rotor to allow the pad to move into and out of contact with the brake rotor as the extensible arm retracts and extends relative to the housing; and
(f) a wheel speed sensor coupled to the linear actuator.

16. The trailer braking system of claim 15, further comprising a computer provided on the trailer and a program storage medium readable by the computer and tangibly embodying one or more instructions executable by the computer to perform a method for braking the trailer, the method comprising:
(a) receiving braking input from the vehicle; and
(b) actuating the linear actuator in response to receipt of the input.

17. The trailer braking system of claim 16, wherein the braking input is received from a seven-pin connector plug provided on the vehicle.

18. A trailer braking system for a trailer coupled to a vehicle, the braking system comprising:
(a) an electric linear actuator comprising:
i a housing;
ii an extensible arm provided at least partially within the housing and at least partially extensible in relationship thereto; and
iii wherein the housing is coupled to the trailer;
(b) a lever having a first end and a second end, wherein the first end of the lever is coupled to the extensible arm;
(c) a piston coupled having a first end and a second end, wherein the first end of the piston is coupled to the second end of the lever;
(d) a brake rotor;
(e) a brake pad assembly, comprising a first brake pad and a second brake pad provided at least partially around the rotor, wherein the brake pad assembly is coupled to the second end of the piston; and
(f) a computer coupled to the linear actuator and a program storage medium readable by the computer and tangibly embodying one or more instructions executable by the computer to perform a method for braking the trailer, the method comprising:
i receiving braking input from the vehicle; and
ii actuating the linear actuator in response to receipt of the input.

19. The trailer braking system of claim 18, further comprising a trailer wheel speed sensor coupled to the computer, wherein the method for braking the trailer further comprises actuating the linear actuator in response to a predetermined input from the trailer wheel speed sensor.

20. The trailer braking system of claim 18, further comprising an antilock braking system coupled to the computer, wherein the method for braking the trailer further comprises actuating the linear actuator in response to a predetermined input from the antilock braking system.
